(19) United States
(12) Patent Application Publication
(10) Pub. No.: US 2009/0189747 A1
(43) Pub. Date: Jul. 30, 2009

(54) CONTROL MECHANISM FOR AN ELECTRICAL APPLIANCE AND METHOD FOR OPERATING THE CONTROL

(75) Inventors: Martin Baier, Ettlingen (DE); Wolfgang Hamm, Bretten (DE); Wolfgang Metzger, Gondelsheim (DE); Roland Boss, Walzbachtal-Johlingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/275,517

(22) Filed: Nov. 21, 2008

(30) Foreign Application Priority Data
Nov. 21, 2007 (DE) 102007057087.4

(51) Int. Cl. H04B 3/36

(52) U.S. Cl. 340/407.1

(57) ABSTRACT

In a hob (11), an operating toggle placed on a front panel (17) has on a connected power control device an actuator (23) for producing a haptic acknowledgement or response in the case of operation. The operating toggle (19) also has a proximity sensor (27). If a hand (29) approaches the operating toggle (19) for operation, this is detected by the proximity sensor and it brings the actuator (23) from a current-economizing standby mode into a normal mode, where it operates normally. If the hand (29) is removed again, it is again brought into the standby mode.

### FIELD OF APPLICATION AND PRIOR ART

The invention relates to an operating or control device for an electrical appliance such as e.g. a domestic electrical appliance in the form of an electric cooker or baking oven, as well as to a method for operating such an operating device.

Operating or control elements such as e.g. rotary toggles or also joysticks on computer game consoles with so-called active haptics are known and where, e.g. using an electric motor, haptic acknowledgements or responses can be provided to an operator, so that e.g. a certain, possibly varying mobility is produced. It is also possible in this way to simulate stops or a locking effect. The problem is that the device producing the haptic response is always activated and therefore consumes energy, even if it is not being used for most of the time, at least with the electrical appliance switched on. However, as for each operation the haptic response is desired, possibilities such as time-controlled switching off cannot or can only be implemented with difficulty.

### Problem and Solution

The problem of the invention is to provide an aforementioned operating or control device and a method for the operation thereof making it possible to obviate the disadvantages of the prior art and in particular to make available a practical, comfortable and also energy-saving operating device.

This problem is solved by an operating device having the features of claim 1 and a method having the features of claims 13, 14, 16 or 17. Advantageous and preferred developments of the invention form the subject matter of the further claims and are explained in greater detail hereinafter. By express reference the wording of the claims is made into part of the content of the description.

The operating device has at least one mobile operating element, which can be a rotary or sliding controller, or an aforementioned joystick or a similar mobile operating element. Through a corresponding movement of the operating element it is possible to initiate different functions or an operation takes place in per se known manner. The operating element is force-connected to an actuator, e.g. by means of a rotary or bearing spindle, in order to produce a haptic response on moving the operating element, which can either constantly exist, e.g. as an aforementioned locking at different setting stages, or also with different difficulties of operation. Alternatively the haptic response can be linked with this specific operation via the actuator and can e.g. also be initiated by a prevailing or operation-set operating state of the electrical appliance.

According to the invention the operating device has a proximity sensor or contact sensor, together with a control circuit, which can bring the operating device or actuator from a normal mode into a standby mode. The energy consumption of the actuator is reduced in said standby mode. The control circuit is constructed in such a way that in a first case of a recognized approach or contact of the operating element by an operator, generally with the hand, this is recognized as such and the actuator is activated from the standby mode and is in particular brought back into a full operating state, i.e. into the normal mode. Once again the actuator operates immediately. In the second case of a non-existent approach or contact with the operating element or if the approach or contact sensor recognizes that a hand has been moved back, the control circuit moves the actuator from the normal mode into the standby mode or leaves it there.

Thus, in a basic state the actuator can be in a standby mode with reduced energy consumption. Advantageously it is substantially or completely switched off or evolves no action. If an operator, generally with the hand, approaches an operating element or contacts it directly, the control circuit recognizes this immediately via the approach or contact sensor and activates the actuator, i.e. brings it into a state of full operating readiness and in certain circumstances also in such a way that a certain resistance exists. This can take place very rapidly, so that an operator scarcely or does not notice that the operating element or its actuator has just been activated. For the following operation, the actuator functions in a complete manner. If the operator again removes the hand from the operating element, this is again detected by the control circuit via the proximity or contact sensor. As a function of the nature of the electrical appliance or the desired operation, the actuator can again be moved from the normal mode into the standby mode or can at least partly and in particular completely be disconnected. Alternatively there can here be a time disconnection following a predetermined time period, e.g. after ten seconds, one minute or a few minutes. This can take account of the fact that, when the operating element has been operated once, with high probability shortly either no or, as a function of the nature of the electrical appliance, once again a further operation takes place.

Thus, the invention makes it possible to greatly reduce the switched-on or activated time of the actuator or in the case of certain electrical appliances reduce it to a fraction, but at the same time the actuator is subject to full operating functionality for haptic response to an operator.

A proximity sensor can advantageously be constructed and operated in such a way that an approach to less than 10 cm, particularly advantageously less than 5 cm brings about the activation, in order to bring the control from the standby mode into the normal mode. This time is adequate for actual contact and can simultaneously prevent unnecessary activation.

As stated hereinbefore, the operating element can advantageously be a rotary toggle with a rotary shaft. It is in particular a rigid rotary spindle or a continuous rotary spindle between the rotary toggle or handle and a setting device, e.g. a power control device. As an alternative to such a rigid rotary spindle it is also possible to provide a magnetic coupling, such as is e.g. known from DE 10 2006 054 764 A1. The actuator then acts with advantage on the rotary shaft and for this purpose is connected to the rotary spindle, or is at least force-connected to the operating element.

The proximity or contact sensor can be constructed purely as a contact sensor, i.e. only responds or records an operation when contacting therewith has taken place. This allows a relatively reliable detection of a contact, which operates in a highly troublefree manner. Such a contact sensor is advantageously located on the operating element, particularly at a location which in the case of an operation so-to-speak is automatically or always contacted. Such contact sensors on a rotary toggle are e.g. known from DE 10 2006 054 764 A1. The advantage of capacitive contact sensors is the tried and tested use thereof and also the fact that no movable mechanical parts are required. They can be incorporated into an operating element or rotary toggle in the manner described in DE 10 2005 019 978 U1. Alternatively it is possible to use contact sensors based on a reflection light barrier, such as are e.g. described in DE 197 00 836 C1.

A contact sensor on the operating element can be constructed as an exposed electrically conductive surface, e.g. of metal, such as high-grade steel or the like. A contact sensor can alternatively be coated with an insulating coating or be placed under a covering on the operating toggle. In the construction as a capacitive sensor it is important that it can capacitively detect a contact with the hand and transmit the same to the control. With an adequately high sensitivity with such a capacitive sensor it is also possible to build up a proximity sensor, because the capacitive coupling between sensor and hand also bridges a distance of a few cm through the air.

It is also possible to use a proximity sensor, which instead of activating the actuator on direct contact, instead detects a desired or probable operation and contact a few centimetres upstream of the operating element and therefore a few milliseconds beforehand, advantageously max. one or two seconds. This time interval can be advantageously used in such a way that at the instant of contact with the operating element the actuator has already been activated. Thus, it is possible for the operator not to notice the prior standby mode of the operating element. As described, such proximity sensors can be constructed capacitively. Alternatively they can be constructed as reflection light barriers according to DE 197 00 836 C1 and can then detect when an operator with the hand e.g. approaches to within 10 cm or less the operating element.

Specifically when using proximity sensors, for the case that the removal of a hand from the operating element is detected, the actuator is immediately brought into the standby mode, i.e. without an aforementioned follow-up time using a time-based disconnection. A further operation can then be detected so-to-speak in anticipation. In the case of a proximity sensor, substantially as with a contact sensor, the control circuit can be set in such a way that the sensor or its evaluation tendentionally more frequently than not detects the presence of an operator's hand, i.e. responds faster, so that in the case of doubt the actuator is tendentionally more frequently and in certain circumstances unnecessarily switched on rather than too infrequently. Even if this somewhat increases the energy consumption, the reduction in energy consumption through switching into the standby mode is more pronounced. A proximity sensor can not only be located on the actual operating element, but instead also on the electrical appliance or a control panel, on or upstream of the operating element. It is advantageously also possible to use one proximity sensor for several operating elements, with particular advantage all the operating elements on the control panel or operating device, which is scarcely possible with a contact sensor.

The actuator can fundamentally be constituted by random, advantageously used actuators, e.g. either with an electric motor, with piezoelectric elements or with a magnetic action, e.g. with magnetostriction.

These and further features can be gathered from the claims, description and drawings and the individual features, either singly or in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Embodiments of the invention are described hereinafter relative to the attached diagrammatic drawings, wherein show:

FIG. 1 An oblique view of an inventive hob on a cooker with several operating toggles on a front panel in front of a hob plate.

FIG. 2 A section through the front panel of the hob of FIG. 1 with a proximity sensor system over the operating toggle.

FIG. 3 A variant of FIG. 2 with a contact sensor directly on the operating toggle.

### DETAILED DESCRIPTION OF THE EMBODIMENTS

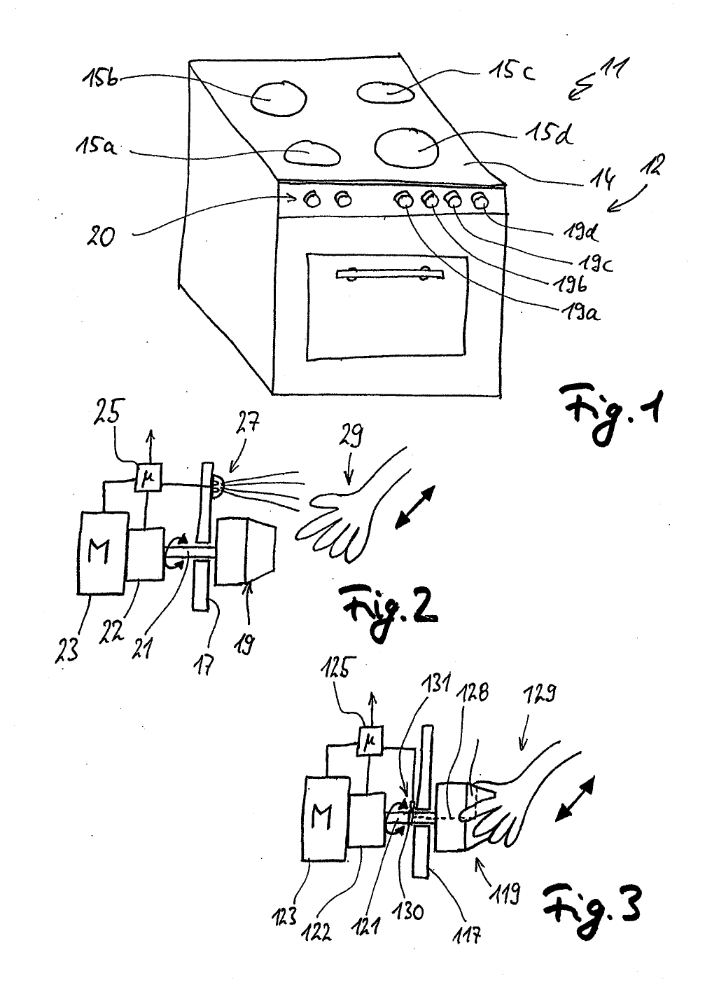

FIG. 1 is an oblique view of a hob 11 on a cooker 12. Hob 11 has a hob plate 14, e.g. of transparent glass ceramic material, with four hotplates 15a-d arranged in distributed manner, as known from the prior art. At the front of the cooker 12 below hob 11 is provided a front panel 17, beneath which is located a baking oven, to which no further reference will be made. Four operating toggles 19a-d are located to the right on the front panel 17. To the left on front panel 17 there are two operating toggles 20 for oven operation. With the operating toggle 19a is associated hotplate 15a, for the purpose of operating or power setting the same. This applies correspondingly for the remaining hotplates and operating toggles.

As is known from the prior art operating toggle 19a can be used for operating hotplate 15a, i.e. for switching it on and setting its power level. The arrangement shown in FIG. 1 corresponds to a conventional arrangement, so that the operating toggles from left to right are associated with the hotplates starting front left and following in a clockwise direction. So that operation can take place instinctively, e.g. with a step-like or increasingly difficulty operable power setting, a corresponding haptic response or acknowledgement is desired and this will be explained in greater detail hereinafter.

According to a first aspect of the invention FIG. 2 is a diagrammatic section through a front panel 17 according to FIG. 1. The operating toggle 19 is located on a rotary spindle 21, which extends through the otherwise closed front panel 17 to a conventional power control device 22. By the rotation of operating toggle 19 and via power control device 22 a power setting can take place on the associated hotplate 15 or its heating device. In order to now obtain the desired haptic response, to the rear on the power control device 22 is provided an actuator 23, which is in particular connected to the continuous rotary spindle 21. The actuator 23 is known per se, e.g. with an electric motor or an electromagnet.

On the front panel 17 above operating toggle 19 is provided a proximity sensor system 27, which acts in an area in front of the front panel 17. Proximity sensor system 27 is also connected to control 25 which, as shown here, is also connected to the power control device 22. Control 25 is also connected to actuator 23, so as to take account of the signals of the power control device 22 together with further external factors so as to control actuator 23 as a function thereof.

Proximity sensor system 27 is known per se from the prior art and can e.g. be constructed as a so-called reflection light barrier. To this extent it can emit light, advantageously with a transmitter in the IR-range. If a hand 29 is now brought close to the operating toggle 19, particularly at a predefined distance thereof, e.g. less than 10 cm or approximately 5 to 10 cm, light is reflected by it. This can be established by the proximity sensor system 27 together with control 25. This is then evaluated by the control as an approach and an intended operation and activation takes place of a display means, which is associated with the hotplate associated with the particular operating toggle 19.

In this embodiment of the invention importance is attached to the distance from the operating toggle 19 or front panel 17 at which the proximity sensor system 27 detects the hand 29. It must in particular be established whether the hand 29 is in fact approaching an operating toggle. To this end one such proximity sensor system 27 can be provided for each operating toggle 19. This can naturally be located within, countersunk or behind the front panel 17 with a transparent window or the like. Alternatively there can be two similar proximity sensor systems, e.g. over the entire left-hand operating toggle 19a and the entire right-hand operating toggle 19d. They can monitor the entire area in front of the operating toggles 19. Thus, admittedly on detecting an approach with hand 29 all the actuators 23 of all the operating toggles 19 are activated. However, this increased cost or energy consumption with respect to the unoperated operating toggles is still justifiable, if as a result there is no need for an individual proximity sensor system 27 for each operating toggle.

For the detection of an approach to one of the operating toggles 19 it makes no sense to have a distance of more than 10 cm, because within this distance there can also be a random or chance moving past, particularly in the case of the hob shown. An activation of an operating toggle 19 or its actuator 23 should only take place when it can be detected whether a hand 29 with a certain level of probability is approaching an operating toggle 19.

The aforementioned problems concerning some uncertainties regarding the approach of a hand to an operating toggle, can be obviated with the arrangement of the alternative variant of the invention shown in FIG. 3. here, with a substantially similar construction of an operating toggle 119 on a front panel 117, a contact sensor 127 can be located directly on the toggle 119. The contact sensor 127 is advantageously made from metal, e.g. high-grade steel, or is electrically conductive and forms at least the front part of the operating toggle 119 which is normally grasped, or even the entire top side. Such an operating toggle is e.g. known in similar form from DE 20 2005 019 978 U1. As a result of an electrical connection 128, shown in broken line form and running on the operating toggle the contact with a contact ring 139 located on the rotary spindle 121 is brought about. A slider 131, together with the electrical connection, passes to the control 125, which can consequently detect if a hand 129 has contacted the operating toggle 119 or contact sensor 127. The operating principle of contact sensor 127, together with control 125, can be that of a capacitive sensor as described in DE 20 2005 019 978 U1. The contact sensor can also be coated with an insulating coating or can be placed beneath a covering on the operating toggle. What is important with this construction as a capacitive sensor is that it capacitively is able to detect a contact with the hand and can transmit it to the control. With an adequately high sensitivity, such a capacitive sensor can also be used to build up a proximity sensor, because the capacitive coupling between sensor and hand also bridges a distance of a few cm through the air.

The advantage of the arrangement of FIG. 3 with a contact sensor 127 on operating toggle 119 is that only the actual contact of the operating toggle 119 with a hand 129 is detected or the activation of actuator 123 is initiated by means of control 125. Admittedly an operator must firstly contact the operating toggle for the actuator 123 to respond. However, this can take place so rapidly that it is not or is scarcely noticed. This in particular allows a reliable detection of a contact.

1. Operating device for an electrical appliance, such as advantageously a domestic electrical appliance, the operating device having at least one mobile operating element for operation by the movement of the operating element, the operating element being force-connected with an actuator for haptic response in the case of a movement of the operating element as a function of the operation or movement, characterized in that the operating device has a proximity or contact sensor and a control circuit in order to bring the actuator from a normal mode into a current-economizing standby mode, the control circuit being constructed so as in a first case of identified approach or contact of the operating element to bring the actuator from the current-economizing standby mode into the normal mode and in a second case of non-existent approach or contact of the operating element to bring the actuator from the normal mode into the current-economizing standby mode or leave it there.

2. Operating device according to claim 1, characterized in that the actuator is separated from a power supply in the standby mode.

3. Operating device according to claim 1, characterized in that the operating element is a rotary toggle with a rotary shaft, the actuator being connected thereto for action on the rotary spindle.

4. Operating device according to claim 3, characterized in that the operating element is a rotary toggle with a rotary shaft, which is mounted on a rigid rotary spindle.

5. Operating device according to claim 1, characterized in that the proximity or contact sensor is placed on or behind an operating panel on which the operating element is located and is constructed as a proximity sensor only.

6. Operating device according to claim 1, characterized in that several operating elements are located on an operating panel, a single proximity sensor being provided for several operating elements.

7. Operating device according to claim 1, characterized in that the proximity or contact sensor is located on said operating element.

8. Operating device according to claim 7, characterized in that the proximity or contact sensor is constructed as a contact sensor only.

9. Operating device according to claim 1, characterized in that the proximity or contact sensor is constructed as an optical sensor with a reflection light barrier as a proximity sensor.

10. Operating device according to claim 1, characterized in that the proximity or contact sensor is constructed as a capacitive sensor.

11. Operating device according to claim 10, characterized in that the proximity or contact sensor is constructed as a capacitive sensor with an electrically conductive sensor surface as the sensor element, the sensor surface being exposed for contact and electrical contacting and the sensor is constructed as a contact sensor only.

12. Operating device according to claim 1, characterized in that the actuator has a motor.

13. Method for operating an operating device according to claim 1, characterized in that the case where by means of the proximity or contact sensor the removal of a hand from the operating device or an operating element is detected, the actuator is immediately brought from the normal mode into the standby mode.

14. Method for operating an operating device according to claim 1, characterized in that for the case that by means of the proximity or contact sensor the removal of a hand from the operating device or an operating element is detected, the actuator is left for a certain time period in the normal mode with activated actuator.

15. Method according to claim 14, characterized in that the actuator is left for half a minute in the normal mode with activated actuator.

16. Method for operating an operating device according to claim 1, characterized in that for the case that by means of the proximity or contact sensor an approach to or contact with an operating element is detected, the actuators of all the operating elements are brought from the standby mode into the normal mode and activated.

17. Method for operating an operating device according to claim 1, characterized in that by means of the proximity or contact sensor in the case of a not clearly detected approach or contact of an operating element by a hand, the case of such an approach or contact is always assumed and the actuator of said operating element is brought from the standby mode into the normal mode and activated.
